(19) United States
(12) Patent Application Publication
(10) Pub. No.: US 2018/0188008 A1
(43) Pub. Date: Jul. 5, 2018

(54) BALLISTIC PROTECTIVE MEDICAL RESPONSE BAG

(71) Applicant: Wayne Ludewig, Old Bethpage, NY (US)

(72) Inventor: Wayne Ludewig, Old Bethpage, NY (US)

(21) Appl. No.: 15/393,949

(22) Filed: Dec. 29, 2016

(51) Int. Cl. F41H 5/08; F41H 1/02; A61J 1/12

(52) U.S. Cl. CPC F41H 5/08; A61J 1/12; F41H 1/02

(57) ABSTRACT

A ballistic protective medical response bag is configured to provide a ballistic shield for the protection of an emergency medical responder. The bag has a layer of ballistic material forming the outer walls of a plurality of compartments in the bag. The compartments are operable between an open and a closed condition and are configured to carry a variety of medical supplies.

### BACKGROUND OF THE INVENTION

The present invention relates to emergency medical response equipment, and more particularly, to protective equipment for emergency medical responders.

Bulletproof vests may be worn by many first responders when an active shooter incident is occurring. However, in many situations an emergency medical responder may be the first responder to arrive at an incident site and may have limited knowledge of an evolving situation. In these instances, the medical responder may not have had an opportunity to carry, or if carried, to don their bulletproof vest before taking actions at a scene to treat a casualty. In those instances, where the medical responder has donned their bulletproof vest, they may not have a means of protecting the casualty they are treating. Similarly, the emergency medical responder may be unable to carry such items because they are carrying their medical response bag and other medical equipment.

For these circumstances it would be beneficial to the emergency medical responder and the casualty to have a level of protection that can be provided by equipment that the medical responder will carry into a casualty situation. As can be seen, there is a need for an improved medical response bag that may be utilized as a ballistic shield during active shooter incidents or other events to provide a protective barrier for the responder or the casualty receiving treatment.

### SUMMARY OF THE INVENTION

In one aspect of the present invention a ballistic medical response bag, includes a lower compartment having a bottom and at least one sidewall defining an interior cavity defined therein; an upper compartment having a top and at least one sidewall defining an upper compartment cavity having a plurality of bins defined in the upper compartment cavity, and attached to the lower compartment via a hinge; a ballistic layer carried in the top, the bottom, and the sidewalls; and a cooperating closure to close the upper compartment with the lower compartment. In other embodiments, the bag may have an outer covering layer for the top, the bottom, and the sidewalls and an interior covering layer covering the top, the bottom, and the sidewalls. The ballistic layer may be a plate carried between the outer covering and the interior covering or it may be formed from a plurality of layers of a ballistic material carried between the outer covering and the interior covering.

In preferred embodiments, the upper compartment comprises includes a first upper compartment; and a second upper compartment, wherein the first and second upper compartments are movable opposite one another between a closed and an open condition. At least one of the upper compartments may be configured with a plurality of bins. A transparent flap operable to cover at least one of the first and the second upper compartments and may include a slide fastener to sealingly close the transparent flap over at least one of the first and the second upper compartments. In yet other embodiments, a flap closure is provided to sealingly join the upper compartment and the lower compartments.

In other aspects of the invention, a ballistic medical response bag is disclosed and claimed in which the bag includes a plurality of compartments having a bottom and a at least one sidewall defining an interior cavity therein, the plurality of compartments is operable between an open position and a closed position. A ballistic layer carried in the bottom, and the sidewalls; and a cooperating closure is provided to fasten the plurality of compartments in the closed position. The bag may include a plurality of bins defined in at least one of the plurality of compartments and a transparent flap may also be included that is operable to cover the plurality of bins. A slide fastener may be used to seal and enclose the plurality of bins. The ballistic layer may be formed as a ballistic plate or as layers of a ballistic fabric.

These and other features, aspects and advantages of the present invention will become better understood with reference to the following drawings, description and claims.

### BRIEF DESCRIPTION OF THE DRAWINGS

FIG. 1 is a front perspective view of an embodiment of a ballistic protective medical response bag in a closed configuration.

FIG. 2 is a side perspective view of the ballistic protective medical response bag in an open configuration.

FIG. 3 is a cross-sectional view taken on line 3-3 of FIG. 1.

FIG. 4 is a cross-sectional view taken on line 4-4 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved emergency medical response bag that provides ballistic protection for an emergency medical responder's use during an active shooter or other hazardous situations.

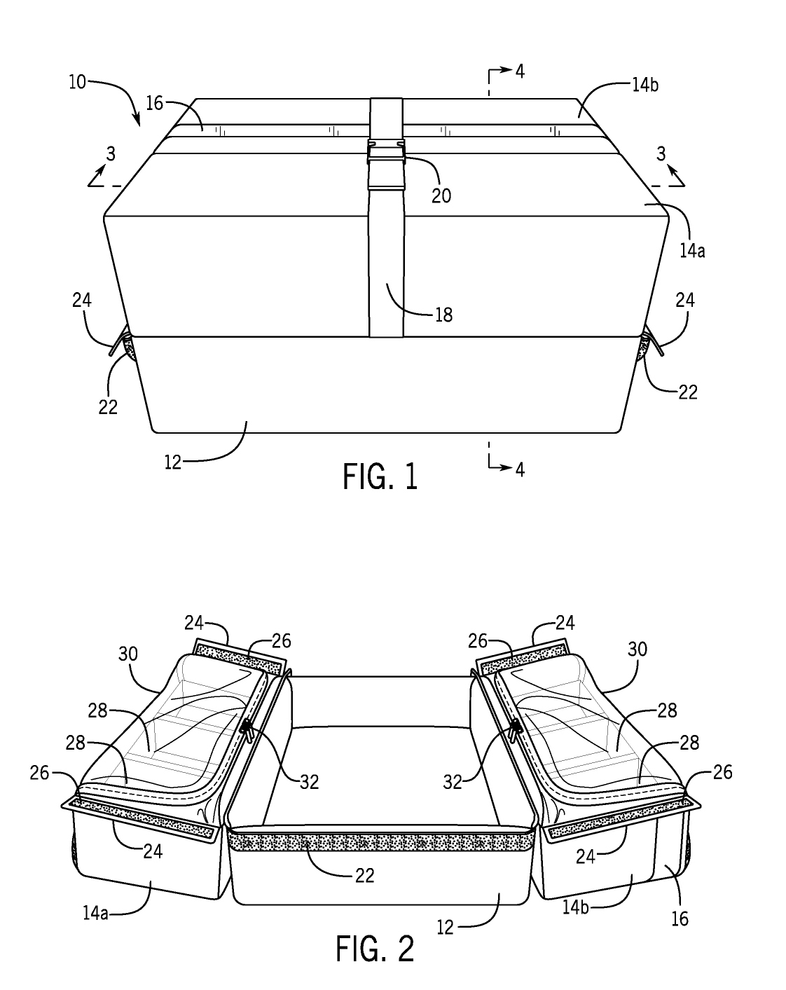

As seen in reference to FIG. 1 a ballistic medical response bag 10 according to an embodiment of the invention is shown in a closed configuration. The bag 10 includes a lower compartment 12, an upper compartment, which is preferably divided between a first upper compartment 14a and a second upper compartment 14b. The bag 10 may also include a reflective strip 16 to provide visibility for the bag during periods of limited visibility.

The bag 10 may also include at least one strap 18 to secure the bag 10 in a closed condition or to secure it within an emergency response vehicle. The strap 18 may be adjustably closed by a buckle 20, or otherwise secured by a fastener, such as snaps, or a hook and pile material. The bag 10 may also include one or more cooperating closures 22, 26 around the periphery of the bag 10 to provide for a sealing closure for the bag 10. The cooperating closures 22, 26 may be a hook and pile material, or a slide fastener that is carried on a flap 14.

As seen in reference to FIG. 2, the ballistic aid bag 10 is shown in an open condition with the first 14a and the second 14b upper compartments hingedly attached along a top lateral edge of the lower compartment 12. The lower compartment 12 includes an interior cavity that may be utilized to carry larger items of medical equipment. The interior cavity may be fitted with straps, dividers, and pockets to organize the medical equipment carried therein.

The upper compartments 14a, 14b are provided with a plurality of interior compartments 28, or bins, for storing medical supplies. The bins 28 may be covered with a transparent flap 30 that has a closure around the respective upper compartment 14a, 14b, via a fastener 32, such as a slide fastener, in order to seal the bins 28 to protect against contamination of the medical supplies and to retain the supplies within the bins 28 when they are not needed.

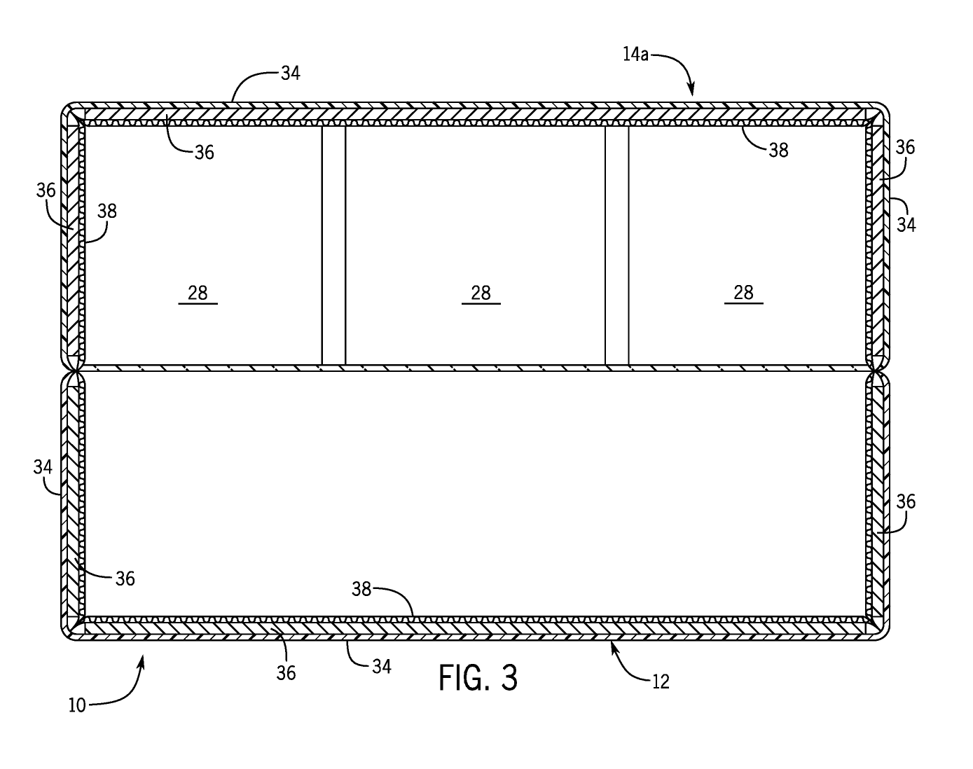

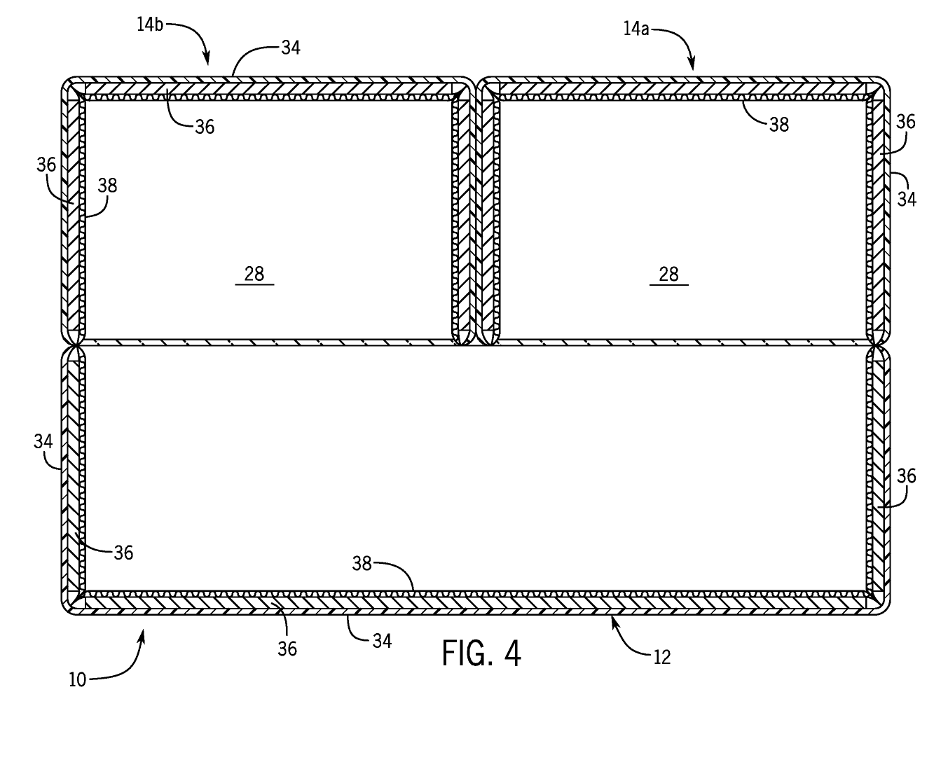

As seen in reference to FIG. 3 the internal arrangement of the upper 14 and lower 12 compartments is illustrated when the bag 10 is in the closed condition. As may further be seen, the sidewalls of the bag 10 include an outer covering 34, an interior lining 38, and a ballistic layer 36, carried between the outer covering 34 and the interior lining 38. As seen in reference to FIG. 4, the interior sidewalls of the upper compartments 14a, 14b are provided with a ballistic layer 36 as well, thereby providing multiple layers of ballistic protection in either the open or the closed condition. The outer covering 34 may be formed of any suitable material, such as ruggedized fabrics, plastics, and the like. The interior lining 38 may be of a suitable cloth material and may include padding for protection of sensitive medical equipment. The ballistic layer 36 may include layers of ballistic materials, such as Kevlar®, and more preferably plates of a ballistic material such as Hardwire Armor Systems but not limited to such.

As will be appreciated, the ballistic medical response bag 10 may be formed in a variety of shapes, sizes, and configurations, depending upon the needs or skills of the emergency medical responder or an anticipated casualty's medical conditions. Likewise, the internal compartments 12, 14 may include a variety of configurations for organizing and storing emergency medical supplies. While described in the context of emergency medical response, it will also be appreciated that the ballistic bag 10 of the present invention may also be used for other occupations and specialties that may require the carriage of equipment to potentially evolving active shooter situations and ballistic hazard environments.

The ballistic medical response bag 10 of the present invention may be used in a variety of ways. For example, when a first responder or person designated as such, arrives in the area of an incident, they could take the ballistic bag 10, which serves as a carry bag for medical equipment and supplies. If a shooter or a person with a knife attempts to attack the responder, or a casualty, the responder simply opens or otherwise utilize the bag 10 to shield themselves, and is thereby protected in a similar fashion to a bullet proof vest. Similarly, in instances where a casualty may require initial treatment before being moved from a hazardous location, the bag 10 may be placed in a protective position between a shooter, or other ballistic hazard, and the medical responder may treat the casualty in a protected posture.

It should be understood, of course, that the foregoing relates to exemplary embodiments of the invention and that modifications may be made without departing from the spirit and scope of the invention as set forth in the following claims.

What is claimed is:

1. A ballistic medical response bag, comprising:
a lower compartment having a bottom and at least one sidewall defining an interior cavity defined therein;
an upper compartment having a top and at least one sidewall defining an upper compartment cavity having a plurality of bins defined in the upper compartment cavity, and attached to the lower compartment via a hinge;
a ballistic layer carried in the top, the bottom, and the sidewalls; and
a cooperating closure to close the upper compartment with the lower compartment.

2. The ballistic medical response bag of claim 1, further comprising:
an outer covering layer covering an outer surface of the top, the bottom, and the sidewalls; and
an interior covering layer covering in interior surface of the top, the bottom, and the sidewalls.

3. The ballistic medical response bag of claim 2, wherein the ballistic layer is a plate carried between the outer covering and the interior covering.

4. The ballistic medical response bag of claim 2, wherein the ballistic layer is formed from a plurality of layers of a ballistic material carried between the outer covering and the interior covering.

5. The ballistic medical response bag of claim 1, wherein the upper compartment comprises:
a first upper compartment; and
a second upper compartment, wherein the first and second upper compartments are movable opposite one another between a closed and an open condition.

6. The ballistic medical response bag of claim 5, further comprising:
a plurality of bins defined within at least one of the first and second upper compartments.

7. The ballistic medical response bag of claim 6, further comprising:
a transparent flap operable to cover at least one of the first and the second upper compartments.

8. The ballistic medical response bag of claim 7, further comprising:
a slide fastener to sealingly close the transparent flap over at least one of the first and the second upper compartments.

9. The ballistic medical response bag of claim 1, further comprising:
a flap closure to sealingly join the upper compartment and the lower compartments.

10. A ballistic medical response bag, comprising:
a plurality of compartments having a bottom and a sidewall defining an interior cavity therein, the plurality of compartments operable between an open position and a closed position;
a ballistic layer carried in the bottom, and the sidewalls; and
a cooperating closure to fasten the plurality of compartments in the closed position.

11. The ballistic medical response bag of claim 10, further comprising:
a plurality of bins defined in at least one of the plurality of compartments.

12. The ballistic medical response bag of claim 11, further comprising:
a transparent flap operable to cover the plurality of bins.

13. The ballistic medical response bag of claim 12, further comprising:
a slide fastener to sealingly enclose the plurality of bins.

14. The ballistic medical response bag of claim 10, wherein the ballistic layer comprises a ballistic plate.

15. The ballistic medical response bag of claim 10, wherein the ballistic layer comprises layers of a ballistic fabric.
